(19) United States
(12) Patent Application Publication
(10) Pub. No.: US 2024/0024189 A1
(43) Pub. Date: Jan. 25, 2024

(54) THERAPEUTIC MASSAGE DEVICE

(71) Applicant: Scientific Fitness, LLC, Huntersville, NC (US)

(72) Inventors: Jeneva Anne Gatses, Huntersville, NC (US); Stephen Gatses, Lemont, IL (US); Krissa Watry, Reno, NV (US)

(73) Assignee: Scientific Fitness, LLC, Huntersville, NC (US)

(21) Appl. No.: 17/871,009

(22) Filed: Jul. 22, 2022

(51) Int. Cl. A61H 15/00

(52) U.S. Cl. CPC A61H 15/0092; A61H 2015/0042

(57) ABSTRACT

The present invention provides a therapeutic massage device having a tapered cylindrical body, a flat base and a dome-shaped top. The therapeutic massage device of the present invention is manufactured from a natural material, such as natural cork tree bark, that is free of rubbers and/or adhesives. The therapeutic massage device may be manufactured by shaping the desired shape from a single piece of raw natural material.

### FIELD

The present disclosure generally relates to an improved manual massage therapy device.

### BACKGROUND OF THE INVENTION

Massage therapy has many benefits including, relief of sore muscles. There are many different massage styles and techniques to address specific muscles and muscle injuries. Neuromuscular therapy, is a specialized form of massage therapy intended to address trigger points, or small areas of a muscle where the tissue is contracted.

There are various tools for neuromuscular therapy and other massage techniques. Some of these tools are intended for use by a licensed massage therapist and some are intended for use at home by the user. Some devices may be intended for dual purpose, which is for use by a licensed therapist and for use at home by the user.

Many tools currently on the market are made of rubber, plastic, foam, and/or other synthetic materials. The manufacture of many of these synthetic materials includes the use of many toxins that may inadvertently remain in the finished product. Additionally, these materials are frequently not environmentally friendly.

In some cases, current tools are pyramidal in shape with the intention of providing concentrated pressure on a small area of the muscle. In many cases, the top of the tool, intended to provide concentrated pressure, is too small, and/or too pointed, and can cause discomfort, or inadvertent muscle tension. In other cases, the tool is too pliable to provide adequate pressure on the target area.

It is an object of the present invention to provide an improved therapeutic massage device that addresses the above problems with current tools or devices.

### BRIEF SUMMARY

Embodiments of the present disclosure address the above needs and/or achieve other advantages by providing a therapeutic massage device and method of manufacture of said device.

In one aspect, the present disclosure provides a therapeutic massage device. The therapeutic massage device has a tapered cylindrical body; a flat base, with a first circumference; and a dome-shaped top. In some embodiments, the therapeutic device has a second circumference between the flat base and the dome-shaped top.

In some embodiments, the first circumference of the therapeutic massage device has a diameter of about 2.25 inches to about 2.5 inches. Additionally, or alternatively, the first circumference may have a diameter of about 2.40 inches. In some embodiments, the second circumference has a diameter of about 1.8 inches to about 2.2 inches. Additionally, or alternatively, the diameter of the second circumference is about 2.00 inches.

In some embodiments, the dome-shaped top of the therapeutic device has a flat surface. In some embodiments, the flat surface comprises a diameter of about 0.25 to about 0.35 inches. Additionally, or alternatively, the diameter of the flat surface is about 0.32 inches.

In some embodiments, the distance between the first circumference and the second circumference is about 1.25 inches to about 1.45 inches. Additionally, or alternatively, the distance between the first and second circumference is about 1.38 inches. In some embodiments, the distance between the second circumference and the dome-shaped top is about 0.65 inches to about 0.80 inches. Additionally, or alternatively, the distance between the second circumference and the dome-shaped top is about 0.72 inches.

In another aspect, the present disclosure provides a therapeutic massage device. The therapeutic massage device comprising: a flat base with a first circumference having a first diameter; a tapered cylindrical body, adjacent to the first circumference, with a second circumference having a second diameter; and a dome-shaped top adjacent to the second circumference. The therapeutic massage device may further comprise a first length defined as the distance from the flat base to the top of the top dome-shaped side, a second length defined as the distance from the first circumference to the second circumference, and a third length defined as the distance from the second circumference to the top of the dome-shaped top.

In some embodiments, the ratio of the first diameter to the second diameter is about 1:0.83. Additionally, or alternatively, the ratio of the first length to the second length is about 1:0.65. In some embodiments, the ratio of the first length to the third length is about 1:0.34.

In some embodiments, the therapeutic massage device is made of cork. Additionally, or alternatively, the therapeutic massage device is made of natural tree cork. In some embodiments, the therapeutic massage device is made of a material with a density of about 130 kg/m³ to about 250 kg/m³. Additionally, or alternatively, the therapeutic massage device is free of rubbers. In some embodiments, the therapeutic massage device is free of adhesives.

In another aspect, the present disclosure provides a method for manufacturing a therapeutic massage device as described herein. The method includes obtaining a solid piece of natural cork tree bark and shaping the natural cork tree bark into a desired shape. The desired shape being a tapered cylinder comprising a flat base and a dome-shaped top. In some embodiments, shaping the solid piece of natural cork tree bark comprises shaving, carving, sanding, and cutting,

### BRIEF DESCRIPTION OF THE DRAWINGS

Having thus described embodiments of the invention in general terms, reference will now be made to the accompanying drawings, wherein:

FIG. 1A illustrates a front view of the therapeutic massage device in accordance with an embodiment of the present invention;

FIG. 1B illustrates a perspective view of the therapeutic massage device in accordance with an embodiment of the present invention;

FIG. 2 illustrates the base of the therapeutic massage device in accordance with an embodiment of the present invention;

FIG. 3 illustrates the top of the therapeutic massage device in accordance with an embodiment of the present invention;

FIG. 4A illustrates the lengths of the therapeutic massage device in accordance with an embodiment of the present invention;

FIG. 4B illustrates the diameter of the base of the therapeutic massage device in accordance with an embodiment of the present invention; and

FIG. 4C illustrates the diameters of the top of the therapeutic massage device in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The present invention relates to a therapeutic massage device. The therapeutic massage device may be used to relieve sore muscles, or neuromuscular pain. Neuromuscular pain has shown to be relieved with neuromuscular therapy. Neuromuscular therapy generally treats trigger points, muscle adhesions, and fascial patterns via manually applying varying levels of focused pressures on the effected muscles. Generally, this type of massage therapy is performed by a neuromuscular therapist. This therapy may be supplemented by the patient at home, using the therapeutic massage device described herein. The therapeutic massage device described herein has various advantages over prior art massage devices. The present invention provides a therapeutic massage device with an ideal hardness for focused pressure and an ideal shape to prevent inadvertent muscle tension while still applying pressure to a focused area. Additionally, the device is made of all natural material free of rubbers and adhesives, so as to avoid toxins and to provide a more environmentally friendly device. The natural material used in the manufacture of the therapeutic massage device is selected to have a desired hardness so as to apply the appropriate amount of pressure on the target area.

The therapeutic massage device described herein is configured for use as a massage therapy tool and/or a neuromuscular therapy tool. In some embodiments, the device may be placed against a flat surface, such as a wall, a chair, or a massage table, the user may be placed on the device focusing on the target area, and the user may be rocked laterally to apply variable pressure to the target area. In other embodiments, the device may be used in a handheld fashion; the device may be held by the base, the dome-shaped top applied to the target area of the user, and the device maneuvered, or rocked, to provide variable pressure to the target area. In some embodiments, the methods described above may be performed by a massage therapist. Additionally, or alternatively, the methods described above may be performed by the user his, or her, self.

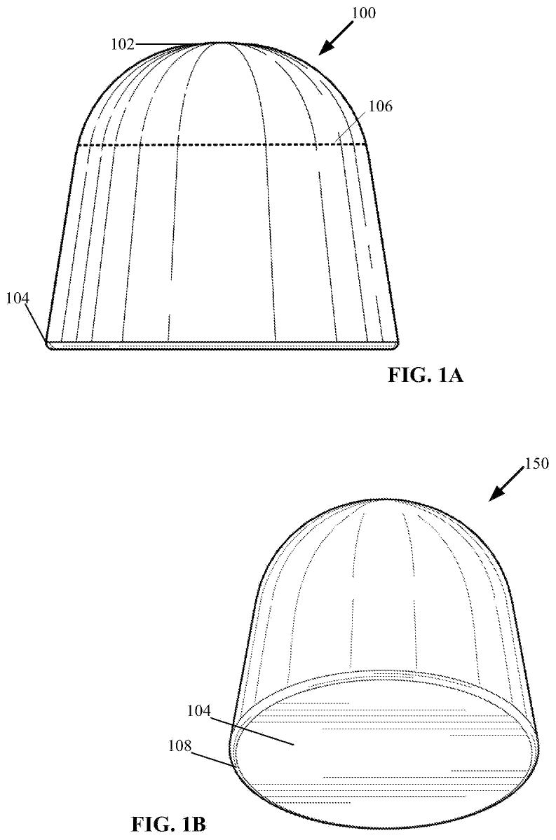

FIG. 1A illustrates a therapeutic massage device 100, according to an embodiment of the present invention. The therapeutic massage device 100 has a flat base 104, comprising a first circumference 108; adjacent to a tapered cylinder with a second circumference 106; which is adjacent to a dome-shaped top 102. FIG. 1B illustrates a perspective view of a therapeutic massage device 150, according to some embodiments of the present invention, wherein the flat base 104 is represented, the flat base 104 having a first circumference 108.

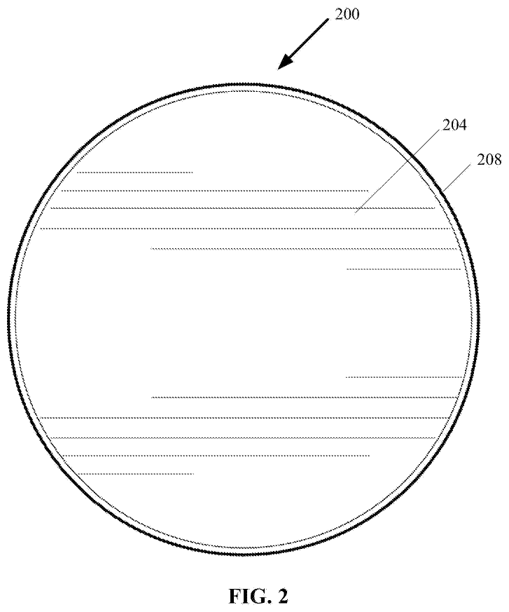

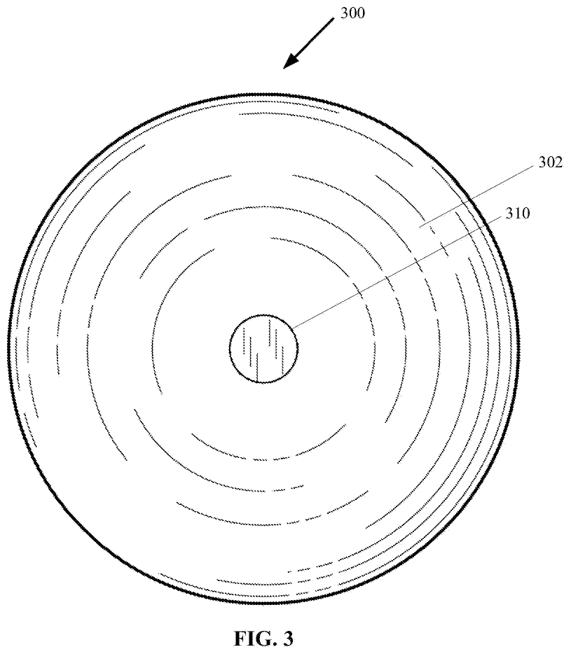

The flat base is further represented in the base view 200, as represented in FIG. 2. The flat base 204 has a first circumference 208. FIG. 3 represents the top-view of the therapeutic massage device 300. In some embodiments, the dome-shaped top 302, has a flat surface 310.

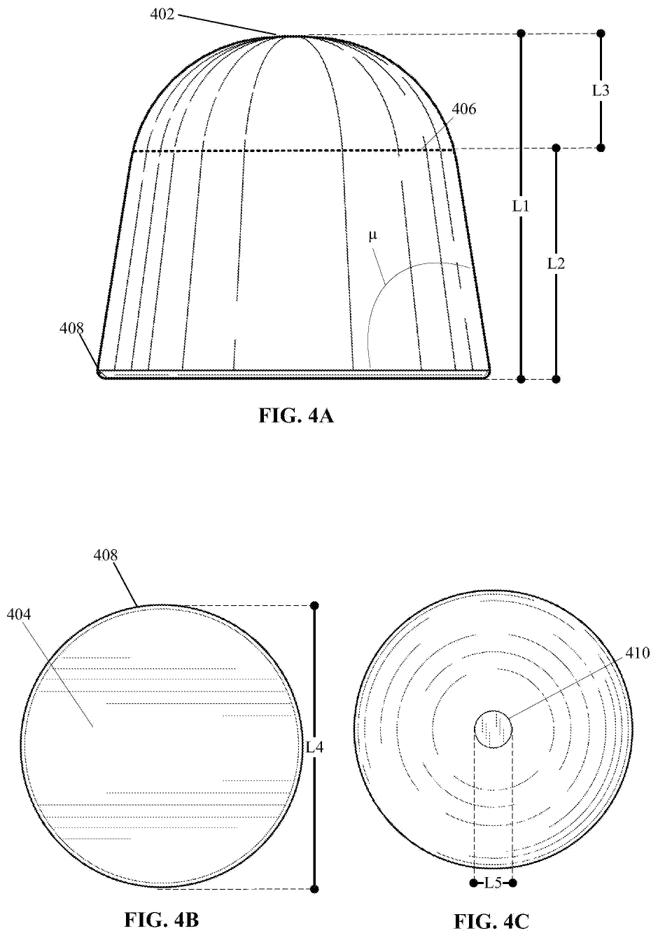

As shown in FIG. 4A there is a distance L1 between the first circumference 408, of the flat base surface 404, and the dome-shaped top 402 of the therapeutic massage device. In some embodiments, L1 is about 1.90 to about 2.20 inches. Additionally, or alternatively, the distance L1 is about 1.90 inches. In some embodiments, the distance L1 is about 1.95 inches. In some embodiments, the distance L1 is about 2.00 inches. In some embodiments, the distance L1 is about 2.05 inches. In some embodiments the distance L1 is about 2.10 inches. In some embodiments the distance L1 is about 2.15 inches. In some embodiments the distance L1 is about 2.20 inches.

As shown in FIG. 4A, there is a distance L2 between the first circumference 408, of the flat base surface 404, and the second circumference 406. In some embodiments, the distance L2 is about 1.25 inches to about 1.45 inches. Additionally, or alternatively, the distance L2 is about 1.25 inches. In some embodiments, the distance L2 is about 1.30 inches. In some embodiments, the distance L2 is about 1.35 inches. In some embodiments the distance L2 is about 1.38 inches. In some embodiments, the distance L2 is about 1.40 inches. In some embodiments the distance L2 is about 1.45 inches.

As shown in FIG. 4A, there is a distance L3 between the second circumference 406 and the dome-shaped top 402. In some embodiments the distance L3 is about 0.65 inches to about inches. Additionally, or alternatively, the distance L3 is about 0.68 inches. In some embodiments, the distance L3 is about 0.70 inches. In some embodiments, the distance L3 is about inches. In some embodiments the distance L3 is about 0.75 inches. In some embodiments, the distance L3 is about 0.80 inches. The apex angle μ is less than 90°. In some embodiments, the apex angle μ is from about 80° to about 88°. Additionally, or alternatively, the apex angle μ is from about 80° to about 84°. In some embodiments, the apex angle μ is 81°.

The fillet radius of the dome-shaped top 302 is defined as the radius of the arc that connects the tapered side wall to the flat surface 410. In some embodiments, the fillet radius of the dome-shaped top may be from about 0.80 to about 0.90. In some embodiments, the fillet radius of the dome-shaped top 302 is 0.85.

As shown in FIG. 4B, the diameter L4 is the diameter of the flat base surface 404. In some embodiments, the diameter L4 is about 2.25 inches to about 2.50 inches. In some embodiments, the diameter L4 is about 2.25 inches. Additionally, or alternatively, the diameter L4 is about 2.32 inches. In some embodiments, the diameter L4 is about 2.40 inches. In some embodiments, the diameter L4 is about 2.40 inches. In some embodiments the diameter L4 is about 2.50 inches.

As shown in FIG. 4C, the diameter L5 is the diameter of the flat surface 410 of the dome-shaped top. In some embodiments, the diameter L5 is about 0.25 inches to about 0.35 inches. Additionally, or alternatively, the diameter L5 is about 0.25 inches. In some embodiments, the diameter L5 is about 0.30 inches. In some embodiments, the diameter L5 is about 0.32 inches. In some embodiments, the diameter L5 is about 0.35 inches.

Additionally, there is a diameter, not shown, of the circle formed by the second circumference. In some embodiments, the diameter of the second circumference is about 1.90 inches to about 2.10 inches. In some embodiments, the diameter of the second circumference is about 1.90 inches. In some embodiments, the diameter of the second circumferences is about 1.95 inches. In some embodiments the diameter of the second circumference is about 2.00 inches. In some embodiments, the diameter of the second circumference is about 2.05 inches. In some embodiments, the diameter of the second circumference is about 2.10 inches.

Alternatively, the dimensions of the therapeutic massage device may be described as ratios. For example, the ratio between the distance from the flat base surface to the dome-shaped top:L1, and the distance from the first circumference (at the flat base surface) to the second circumference:L2 may be about 1:0.65. In another example, L1:L3 may be about 1:0.34. In another example, the ratio of the diameter of the flat base surface L4 to the diameter of the second circumference may be about 1:0.83.

The density of the material used to form the therapeutic massage device may be from about 130 kg/m³ to about 250 kg/m³. The therapeutic massage device described herein may be manufactured of a natural material. In some embodiments, the therapeutic massage device is manufactured completely from natural material and is free of rubbers and/or adhesives. In some embodiments, the therapeutic massage device is manufactured of cork. Additionally, or alternatively, the therapeutic massage device is manufacture of natural cork tree bark.

Natural cork tree bark may be harvested from the cork tree. The cork tree is unique, in that is the only tree that can regenerate after each harvest of its bark due to a thin layer of inner bark that allows the tree to regenerate bark. The bark of the cork tree is harvested, or stripped from the tree, in a manner so that the inner bark layer is not damaged. Cork is entirely natural, reusable, and recyclable. In some cases, the cork tree bark is dried, chipped, and assembled into shapes using rubber and/or adhesives, as is the case with the manufacture of cork wine stoppers. However, cork can also be used in its natural form, without the addition of rubbers or adhesives. Cork is an ideal material for the therapeutic massage device described herein, as it is lightweight, elastic, durable, hypoallergenic, impermeable, and thermally & acoustically insulating. However, other natural materials with similar properties may be used in lieu of cork.

The therapeutic massage device described herein may be manufactured by shaping a solid piece of natural material, such as natural cork tree bark, into the shape of the device. In some embodiments, shaping includes shaving the solid piece of natural material into the appropriate shape. Additionally, or alternatively, shaping includes carving the solid piece of natural material into the desired shape. In some embodiments, shaping includes sanding the solid piece of natural material into the desired shape. Additionally, or alternatively, shaping includes cutting the solid piece of natural material into the desired shape.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications, and substitutions, in addition to those set forth in the above paragraphs, are possible. Those skilled in the art will appreciate that various adaptations, modifications, and combinations of the just describe embodiments can be configured without departing from the scope of the appended claims. The invention may be practiced other than as specifically described herein.

What is claimed is:

1. A therapeutic massage device comprising:
a tapered cylindrical body,
a flat base comprising a first circumference,
a second circumference, and
a dome-shaped top.

2. The therapeutic massage device of claim 1, wherein the first circumference of the therapeutic massage device has a diameter of about 2.25 inches to about 2.50 inches.

3. The therapeutic massage device of claim 2, wherein the diameter of the first circumference is about 2.40 inches.

4. The therapeutic massage device of claim 1, wherein the second circumference of the therapeutic massage device has a diameter of about 1.90 inches to about 2.10 inches.

5. The therapeutic massage device of claim 4, wherein the diameter of the second circumference is about 2.00 inches.

6. The therapeutic massage device of claim 1, wherein the dome-shaped top of the therapeutic massage device comprises a flat surface.

7. The therapeutic massage device of claim 6, wherein the flat surface comprises a diameter of about 0.25 inches to about 0.35 inches.

8. The therapeutic massage device of claim 7, wherein the diameter of the flat surface is about 0.32 inches.

9. The therapeutic massage device of claim 1, wherein a distance between the first circumference and the second circumference is about 1.25 inches to about 1.45 inches.

10. The therapeutic massage device of claim 9, wherein the distance between the first circumference and the second circumference is about 1.38 inches.

11. The therapeutic massage device of claim 1, wherein a distance between the second circumference and the dome-shaped top is about 0.65 inches to about 0.80 inches.

12. The therapeutic massage device of claim 11, wherein the distance between the second circumference and the dome-shaped top is about 0.72 inches.

13. The therapeutic massage device of claim 1, wherein the therapeutic massage device is comprised of cork.

14. The therapeutic massage device of claim 13, wherein the therapeutic massage device is comprised of natural cork tree bark.

15. The therapeutic massage device of claim 1, wherein the therapeutic massage device is comprised of a material with a density of about 130 kg/m³ to about 250 kg/m³.

16. The therapeutic massage device of claim 1, wherein the therapeutic massage device is free of rubbers.

17. The therapeutic massage device of claim 1, wherein the therapeutic massage device is free of adhesives.

18. A therapeutic massage device comprising:
a flat base comprising a first circumference, wherein the first circumference has a first diameter;
a tapered cylindrical body adjacent to the first circumference, wherein the tapered cylindrical body comprises a second circumference, and wherein the second circumference comprises a second diameter; and
a dome-shaped top, adjacent to the second circumference.

19. The therapeutic massage device of claim 18, wherein a ratio of the first diameter to the second diameter is about 1:0.83.

20. The therapeutic massage device of claim 18,
wherein a first length is measured from the flat base to the dome-shaped top;
wherein a second length is measured from the first circumference to the second circumference;
wherein a third length is measure from the second circumference to the dome-shaped top;
wherein a ratio of the first length to the second length is about 1:0.65; and
wherein a ratio of the first length to the third length is about 1:0.34.

21. The therapeutic massage device of claim 18, wherein the therapeutic massage device is comprised of cork.

22. The therapeutic massage device of claim 21, wherein the therapeutic massage device is comprised of natural cork tree bark.

23. The therapeutic massage device of claim 18, wherein the therapeutic massage device is comprised of a material with a density of about 130 kg/m³ to about 250 kg/m³.

24. The therapeutic massage device of claim 18, wherein the therapeutic massage device is free of rubbers.

25. The therapeutic massage device of claim 18, wherein the therapeutic massage device is free of adhesives.

26. A method of manufacturing a therapeutic massage device comprising:
obtaining a solid piece of natural material, and
shaping the solid piece of natural material into a desired shape, wherein the desired shape is a tapered cylinder comprising a flat base, a dome-shaped top.

27. The method of manufacturing a therapeutic massage device according to claim 26, wherein the solid piece of natural material is natural cork tree bark.

28. The method of manufacturing a therapeutic massage device according to claim 26, wherein shaping the solid piece into the desired shape comprises shaving, carving, sanding, or cutting.
